(19) United States
(12) Patent Application Publication
(10) Pub. No.: US 2021/0154584 A1
(43) Pub. Date: May 27, 2021

(54) SYSTEMS AND METHODS FOR DETERMINING POINTS OF INTEREST IN VIDEO GAME RECORDINGS

(71) Applicant: Backbone Labs, Inc., Vancouver, WA (US)

(72) Inventors: Shawn O'Connor, Portland, OR (US); Maneet Khaira, Vancouver, WA (US)

(21) Appl. No.: 16/693,080

(22) Filed: Nov. 22, 2019

(51) Int. Cl. A63F 13/63; A63F 13/211

(52) U.S. Cl. CPC A63F 13/63; A63F 2300/6018; A63F 2300/535; A63F 13/211

(57) ABSTRACT

A device for editing video gameplay, comprising a display, an interface configured to receive one or more outputs from a game controller concurrently with the video game displayed; and one or more processors. The one or more processors are configure to record a video of the video game displayed on the display; store the one or more outputs from the game controller received concurrently with the video game displayed; determine based on the one or more outputs from the game controller time series data indicating an amount of user activity; and align the time series data with the video of the video game.

### FIELD OF THE INVENTION

This disclosure is directed to systems and methods for processing video game data, and in particular, to processing video game data on a computing device based on outputs from a game controller.

### BACKGROUND

In video editing application, to easily identify and trim video gameplay video, typically snapshots of the video frames are displayed in a marquee interface. Generally, this marquee interface is displayed directly below a timeline axis such that a particular position in the timeline corresponds directly to a frame of video. However, these small previews are not particularly useful to locate specific moments in a video gameplay due to the coarse nature of how the frames are displayed. As the timeline or video grows in duration, the conventional snapshot approach becomes less and less useful, requiring a very coarse representation or a scrolling mechanism. Furthermore, a video alone only contains audio and video data, and it can be very difficult to extract meaningful data without a huge amount of video computation.

Embodiments of the disclosure address these and other deficiencies of the prior art.

### BRIEF DESCRIPTION OF THE DRAWINGS

Aspects, features and advantages of embodiments of the present disclosure will become apparent from the following description of embodiments in reference to the appended drawings in which:

FIG. 1 is a block diagram of a system for receiving user input data from a game controller and determining points of interest based on the user input data.

FIG. 2 is a flow chart illustrating operations for determining points of interest based on the user inputs.

FIG. 3 is an example operation for determining an amount of user activity from the user controls of the game controller.

FIG. 4 is an example graphical user interface according to some embodiments of the disclosure.

FIG. 5 is another example graphical user interface according to other embodiments of the disclosure.

### DESCRIPTION

Embodiments of the disclosure provide a device and method for extracting gameplay information to identify important points or regions in video gameplay footage. As will be discussed in more detail below, one or more of game controller inputs, sensor inputs, and audio data may be analyzed to determine the interesting points or regions in the video gameplay footage, which may be done by outputting time series data. The time series data may include aligning the video gameplay footage with controller inputs and marking points of interest in the time series data. The time series data may be displayed concurrently to a user with video viewing and editing functions.

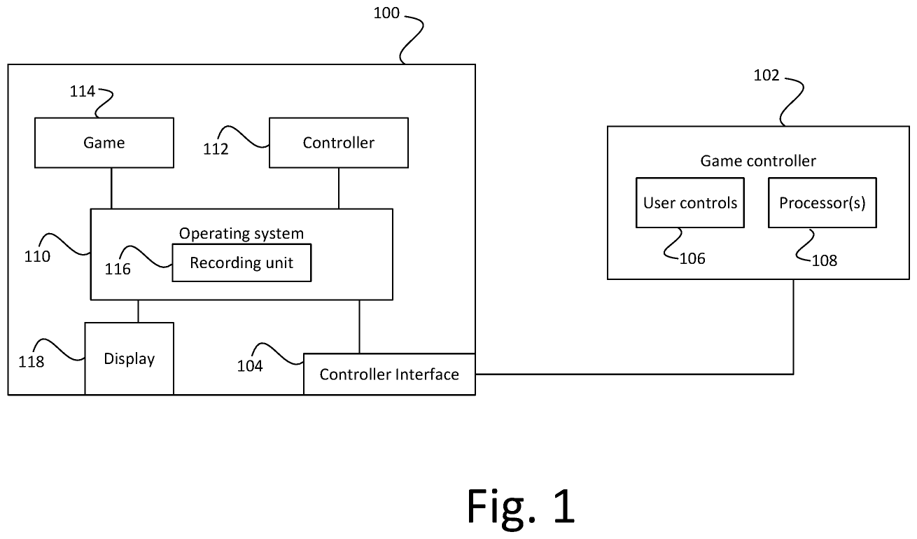

FIG. 1 illustrates an example block diagram of a system for capturing video game highlights or points of interest, according to some embodiments of the disclosure. The system includes a computing device 100 and a video game controller 102. The computing device 100 may be, for example, a mobile device, such as, but not limited to, a mobile or smart phone, a laptop computer, a tablet device, a game console, or any other type of mobile device. In some embodiments, the computing device 100 may be a personal computer, such as a desktop computer. The video game controller 102 may be connected to the computing device 100 through an interface 104, either wired or wirelessly. For example, if the interface 104 is wired, the interface may be a lightning port or a universal serial bus (USB) port, or any other type of interface to send and receive data between the computing device 100 and the game controller 102.

The game controller 102 includes one or more user controls 106, such as, but not limited to, buttons, switches, joysticks, etc., which a user may use when playing a video game displayed on the computing device 100 or otherwise interacting with the computing device 100. For example, the game controller 102 may be a Human Interface Device (HID), such as a keyboard, mouse, or any input device having a combination of buttons, switches, and/or joysticks to interact with a video game. The output of the user controls 106 are sent to the controller interface 104 through one or more processors 108. The one or more processors 108 may sample the user controls 106 at a high rate and output those high rate samples to the computing device 100 to control various aspects of a game being displayed on the computing device 100. As will be discussed in more detail below, the one or more processors 108 may also packetize the user controls 106 for output to a controller unit 112 on the computing device 100 to assist with identifying points of interest in a video game being played by the user. The output from game controller 102 may then be received by an operating system 110 of the computing device 100.

The operating system 110 may pass the user controls to the game unit 114 and/or the controller unit 112. The game unit 114 may stream from a cloud or other connected device the video game or store the video game directly on the computing device 100. The operating system 110 can coordinate the sending and receiving of data with the game controller 102 and the controller unit 112, so that the controller unit 112 can process the incoming user control data. Further, as will be understood by one skilled in the art, the computing device 100 may include a number of connected, but separate, components that cooperate in conjunction with each other to achieve the operations discussed below. For example, the display, the game unit 114, and/or the controller unit 112 may be located on different devices and/or different processors.

During operation, the game unit 114 can cause a video game to display on a display 118 to a user, which can be played by the user through the controller 102 using the user controls 106. The high sampled rate user controls from the game controller 102 are sent to the game unit 114 for operation of the game. However, a packetized version of the user controls are also sent to the controller 112 to identify points of interest in the video game being displayed by the game unit 114. The game unit 114 can be operating in the foreground of the computing device 100 while the controller unit 112 is operating in the background. That is, the user will be interacting directly with the game controller 102 and the game displayed by the game unit 114, while the controller unit 112 is receiving and processing data in the background.

The operating system 110 may include a recording unit 116 or any other component that captures the video game data displayed by the game 114. This captured video can then be sent to the controller unit 112 for processing either in real-time or near real-time, or once the game has been completed by the user and recording has ceased. In some embodiments, the recording unit 116 may also capture not just the video of the game being played, but also the audio of the game being played.

When the controller unit 112 has received both the user outputs from the controller 102 and the recorded video game from the recording unit 116, the controller unit 112 can process the user outputs to generate time-series data, which as will be discussed in more detail below, can be used to highlight points of interest in the recorded video game to assist a user with editing the recorded video game. In some embodiments, the controller unit 112 may be located on another device, such as a personal computer and the controller unit 112 may receive the recording from the recording unit 116, as well as the user controls 106 through the interface 104.

Although FIG. 1 illustrates the computing device 100 as a single device, as will be understood by one skilled in the art, the various components of the computing device 100 may not all be contained in the same device. For example, a game unit 114 may be located in a cloud and be streamed to a display device 118, such as a TV, mobile device, laptop, etc. The game controller 102 may be connected to either the display device 118 which communicates with the cloud, or may be connected wirelessly directly to the cloud. The controller unit 112 may be included either in the cloud as well, or may be included on the display device 118.

As another example, the game unit 114 may be stored locally on the computing device 100, and may be presented on a display 118 either attached to, such as a television or computer monitor, or incorporated into the computing device 100, such as a screen of a mobile device, laptop, or tablet, for example. In some embodiments, the controller unit 112 may be stored locally as well on the computing device 100, as illustrated in FIG. 1, or the controller unit 112 may be stored in the cloud and outputs from the game controller 102 may be sent either directly to the controller unit 112 in the cloud wirelessly, or be sent to the controller unit 112 in the cloud through the computing device 100.

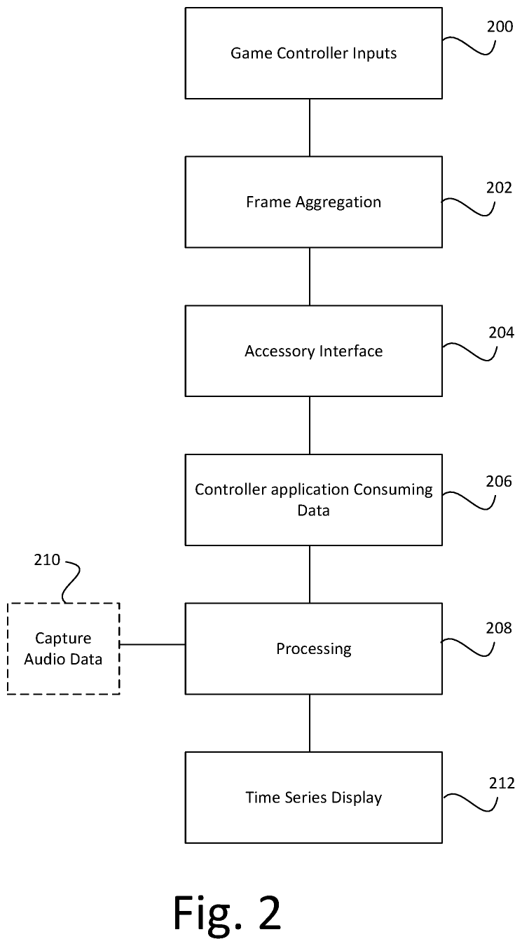

FIG. 2 illustrates an operation for converting user controls into time-series data. The operations illustrated in FIG. 2 can be performed concurrently with the game controller 102 sending outputs through the interface 104 for playing the game by the user. That is, the operations illustrated in FIG. 2 can be performed in the background of the computing device 100.

Initially in operation 200, the one or more processors 108 sample the output from the user controls 106 at a high rate, such as 120 Hertz (Hz). In operation 202, the sampled outputs can be aggregated into longer duration frames by the one or more processors 108. That is, data may be collected for a period of time and aggregated into a frame. The period of time may be any period of time, such as, but not limited to, a quarter of a second or half a second. During the frame aggregation of operation 202, the one or more processors 108 also packet the aggregated frames to be sent to the interface 104 in operation 206.

The information is transmitted from the interface 104 to the controller unit 112 in operation 206. In operation 206, the controller unit 112 can instruct a memory (not shown) to store the packets from the game controller 102. In some embodiments, in operation 208, the controller unit 112 can begin processing the data as soon as it is received. In other embodiments, the processing may be delayed until a larger set of data is received from the interface 104. The processing in operation 208 runs continuously until a recording of the video game has ceased and the last of the data from the game controller 102 is received.

Processing in operation 208 includes determining periods of interest in the video game based on the received data from the game controller 100. For example, if higher game controller 102 activity is identified by the controller unit 112 in a portion of the data, then this data can be identified as a period of interest.

In some embodiments, game audio data may also be collected, as illustrated in operation 210. The audio data may be collected, for example, by the recording unit 116. The controller unit 112 may then in operation 208 process the audio data to identify periods of interest. For example, loud portions of the video game may be identified as a period of interest or, loud portions of the video game may identified as a period of interest if the user controls during that time period are above a certain threshold of activity. For example, although the user control 106 for a certain period alone may not equate to a point of interest, if the audio from the game at this time period is louder than other points, the controller unit 112 may label this section as a period of interest.

In operation 212, the controller unit 112 can generate time series data, which includes aligning the recorded video game from the recording unit 116 and the inputs from the game controller 100. Periods of interested identified by the controller 112 can then be aligned with the recorded data to assist a user in identifying interesting or important moments in the game. In some embodiments, a graph of the user control data can be generated by the controller unit 112. The graph may be, for example, a bar plot or a waveform, to indicate the amount of activity determined by the controller unit 112 for the user controls 106.

Although not illustrated, in some embodiments, a sensor may be provided on the game controller 102 to provide additional data and/or to provide the output for determining points of interest in the game. For example, the sensor may be a motion sensor, such as an accelerometer, to sense movement of the controller 102. The sensor data may be used to indicate when the game is being played versus navigating controls on the computing device 100, for example. In other embodiments, the sensor data may also be used by the controller unit 112 to determine points of interest in the game. For example, if the game controller 102 itself is moving a lot, it may indicate that the user is playing an interesting portion of the game. In some embodiments, the game controller 102 may be worn by a user, and the amount of motion sensed by a sensor in the game controller 102 may be used as the output for determining the points of interest in the game. In such embodiments, the user inputs 106 are not used to determine the amount of activity, but rather the sensor data is used to determine the amount of activity.

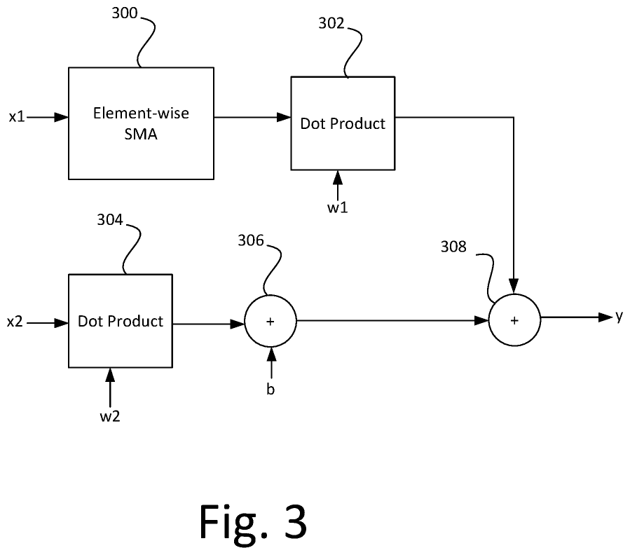

FIG. 3 is an example of an operation that may be used by the controller unit 112 to determine the amount of activity by the user controls 106. However, embodiments of the disclosure not limited to the operation illustrated in FIG. 3 and any operation used to determine an amount of activity from the game controller may be used.

The activity is output as y in FIG. 3 and may be aligned with the time the user controls 106 are received so that the activity may be aligned with the recorded video from the recording unit 116, which is also received by the controller unit 112. The variable x1 in FIG. 3 represents one or more joystick vectors and the variable x2 represents all controller switches, buttons, and triggers. In block 300, an element-wise simple moving average (SMA) smooths the one or more joystick vectors x1 because these outputs tend to be noisy. This is combined using dot product 302 with a joystick weight vector w1.

The switches, buttons, and trigger vectors x2 and a switches, buttons and trigger weight w2 are combined in dot product block 304 and added to a minimum activation bias b in the summer 306. The output of the dot product block 302 and the summer 306 are then added together through summer 308 to output the amount of level activity y. However, as will be understood by one skilled in the art, this is just one example of how the activity may be determined from the switches, buttons, triggers, and joystick outputs. Further processing may be provided to the dot product output 302 or the summer output 306 to more accurately determine the amount of activity.

The final vector for the button and the joystick are then combined in the summer 314 to determine the output y, which is recorded over time and may be normalized when all of the data is received. Output y can then be graphed by the controller unit 112 as a waveform or bar graph, for example, to compare to the recorded video game. An activity threshold may be set to determine the points of interest. For example, if the output data is above the activity threshold, that point in the video game is marked as a point of interest. In some embodiments, the activity threshold may be a set threshold, or the activity threshold may be determined based on the amount of activity detected during the recorded video game. For example, a recorded game with less activity overall may have a lower threshold in some embodiments.

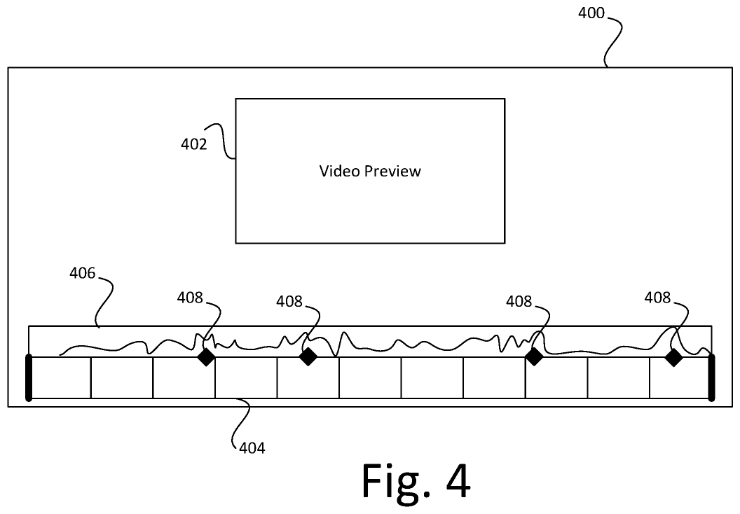

FIG. 4 illustrates an example of a graphical user interface 400 that maybe displayed to a user on the computing device 100 through the controller unit 112. The graphical user interface 400 may include various controls (not shown) for editing the recorded video game, such as clipping the video game or slowing down the video game at particular times, as will be understood by one skilled in the art.

The graphical user interface 400 may include a video preview window 402 to display the recorded video game. A timeline bar 404 is also displayed and may contain a number of frames 406 of the recorded video game. In some embodiments, the timeline bar 404 may also be used to trim the recorded video game.

In some embodiments, the graphical user interface 400 may also include an activity graph 406. The activity graph 406 is time-aligned with the timeline bar 404 and can display the amount of activity in certain areas. In some embodiments, as illustrated in FIG. 4, markers 408 can be displayed on the activity graph 406 to indicate points of interest.

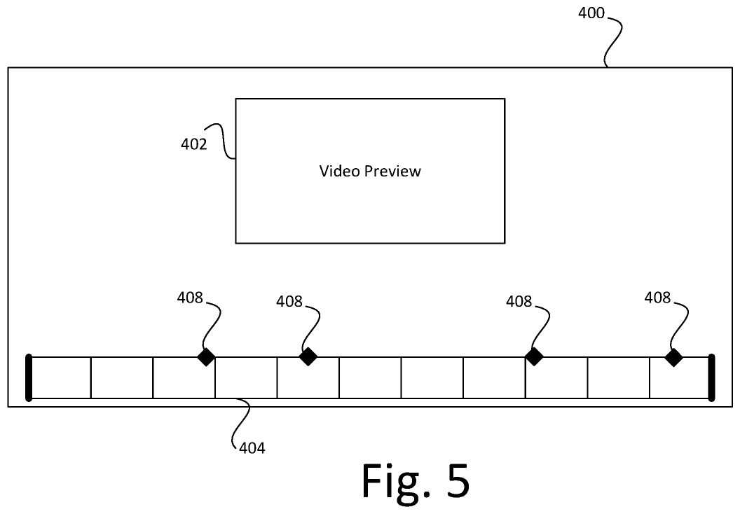

In some embodiments, as illustrated in FIG. 5, only markers 408 are provided above or on the timeline bar 404 and the activity graph 406 is not included. Further, although not illustrated in FIGS. 5 and 6, if audio data is also recorded to determine points of interest in the video game, then a graph of the audio data may also be provided time-aligned with the recorded video and the activity data.

As discussed above, embodiments of the disclosure allow a user to quickly identify points of the game which may be particularly interesting based on the amount of activity captures on the game controller 102. Generally, the more activity the game controller 102 is receiving, the more interesting that point of the game will be to a user. Embodiments of the disclosure allow a user to quickly discern which areas of the recorded video game may be of interest, without having to scroll or watch through the entire recorded video to identify those areas.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

We claim:

1. A device for editing video gameplay, comprising:
a display;
an interface configured to receive one or more outputs from a game controller concurrently with the video game displayed; and
one or more processors configured to:
record a video of the video game displayed on the display;
store the one or more outputs from the game controller received concurrently with the video game displayed;
determine based on the one or more outputs from the game controller time series data indicating an amount of user activity; and
align the time series data with the video of the video game.

2. The device of claim 1, wherein the device is a mobile device.

3. The device of claim 1, wherein the one or more processors are further configured to instruct the display to display the time series data aligned with the video of the video game.

4. The device of claim 1, wherein the one or more processors are further configured to determine points of interest in the video of the video game by determining which portions of the time series data are greater than a threshold and selecting the portions of the time series data that are greater than the threshold as points of interest.

5. The device of claim 4, wherein the one or more processors are further configured to instruct the display to display the time series data marked with the points of interest.

6. The device of claim 5, wherein the one or more processors are further configured to instruct the display to display the times series data marked with the points of interest concurrently with the video of the video game.

7. The device of claim 4, wherein the one or more processors are further configured to instruct the display to display portions of the video of the video game that align with the points of interest in the time series data.

8. The device of claim 1, wherein the interface configured is further configured to receive sensor data from the game controller, and the one or more processors are further configured to determine the time series data indicating the amount of user activity based on the sensor data.

9. The device of claim 8, wherein the sensor data is accelerometer data.

10. The device of claim 1, wherein the one or more processors are further configured to record audio of the video of the video game displayed on the display and determine the time series data indicating the amount of user activity based on the audio of the video of the video game.

11. One or more computer-readable storage media comprising instructions, which, when executed by one or more processors of a computing device, cause the computing device to:
record a video of a video game displayed on a display;
receive and store one or more outputs from a game controller received concurrently with the video game displayed;
determine based on the one or more outputs from the game controller time series data indicating an amount of user activity; and
align the time series data with the video of the video game.

12. The one or more computer-readable storage media of claim 11, wherein the instructions further cause the computing device to display to display the time series data aligned with the video of the video game.

13. The one or more computer-readable storage media of claim 11, wherein the instructions further cause the computing device to determine points of interest in the video of the video game by determining which portions of the time series data are greater than a threshold and selecting the portions of the time series data that are greater than the threshold as points of interest.

14. The one or more computer-readable storage media of claim 13, wherein the instructions further cause the computing device to display the time series data marked with the points of interest.

15. The one or more computer-readable storage media of claim 14, wherein the instructions further cause the computing device to display the times series data marked with the points of interest concurrently with the video of the video game.

16. The one or more computer-readable storage media of claim 13, wherein the instructions further cause the computing device to display portions of the video of the video game that align with the points of interest in the time series data.

17. A method for determining video game highlights, comprising:
receiving one or more outputs from a game controller, the one or more outputs corresponding to one or more user inputs;
recording a video game displayed on a display;
determine a user activity level based on the one or more outputs from the game controller;
determining one or more points of interest based on the user activity level; and
displaying the one or more points of interests corresponding to a timeline of the recorded video game.

18. The method of claim 17, further comprising displaying the user activity level concurrently with the one or more points of interest.

19. The method of claim 17, wherein determining the one or more points of interest includes selecting the one or more points of interest when the activity level is greater than a threshold.

20. The method of claim 17, wherein displaying the user activity level includes displaying the user activity level in a bar graph or as a waveform.
